(19) United States
(12) Patent Application Publication
(10) Pub. No.: US 2021/0059226 A1
(43) Pub. Date: Mar. 4, 2021

(54) OFF-WATER SHUTDOWN PROTECTION MECHANICAL HEATER

(71) Applicant: Wen-Hong Su, Taipei City (TW)

(72) Inventor: Wen-Hong Su, Taipei City (TW)

(21) Appl. No.: 16/553,186

(22) Filed: Aug. 28, 2019

(51) Int. Cl. A01K 63/06; H05B 1/02; H05B 3/80; H05B 3/44

(52) U.S. Cl. CPC A01K 63/065; H05B 1/0202; H05B 2203/021; H05B 3/44; H05B 3/80

(57) ABSTRACT

An off-water shutdown protection mechanical heater includes a tube and a cap mounted to an end of the tube. The tube includes therein an off-water protection transducer, one of a relay and a TRIAC, a circuit board including a bimetal plate, and a heating element. When he off-water protection transducer detects a situation of being immersed in water, the one of the relay and the TRIAC turns on to conduct electricity and the bimetal plate detects a temperature of water and undergoes deformation by the temperature to control the heating element to generate heat or not; and when the off-water protection transducer detects a situation of being removed out of water, the one of the relay and the TRIAC turns off to cut off electricity, making the heating element not generating heat. The off-water protection transducer ensures that electricity is quickly cut off upon removal out of water.

### TECHNICAL FIELD OF THE INVENTION

The present invention provides an aquarium heater, and more particularly to an off-water shutdown protection mechanical heater.

### DESCRIPTION OF THE PRIOR ART

Fishes are poikilothermal creatures. Each species of fish has specific upper and lower limits of temperature resistance as the most optimum temperature range. In the most optimum temperature range, fishes demonstrate the most vivid conditions of feeding, breathing, and digesting and also show enhanced metabolism for rapid growth. When the inhabitation environments of aquariums are not properly kept in the optimum temperature range for a long term, the aquariums may suffer abnormality of metabolism, restricted growth, and even death.

People keep and raise fishes as pets all over the world. However, different areas on Earth have different weather conditions. Although indoor temperature in the summertime may be sufficient to prevent the water temperature of an aquarium tank from becoming too low, in the wintertime, the water temperature of the aquarium tank drops as varying with the indoor temperature. To maintain a comfortable vivarium condition for aquatic animals or fishes, most of the breeders provide a heater in the aquarium tank in the wintertime. Early-day heaters have evolved from traditional heaters, which require manual observation of the temperature of the aquarium tank and manual control of a switch of the heater for shutting down the heater, to mechanical heaters and electronic heater that features automatic detection of water temperature by means of a heater for timely taking automatic operations of deactivation and activation.

The mechanical heater has a temperature control structure and principle involving a bimetal plate having two metals of different coefficients of thermal expansion. Due to different degrees of curving resulting from different temperatures of water, automatic contacting and detaching are carried out to control a heating element to generate heat or not.

However, to date, no mechanical heater having an off-water shutdown protection function is available. This often causes a situation that the aquarium heater shows extra high residual heat or improper control of water temperature may occur. For example, when the water level of an aquarium drops due to for example evaporation of water, if water is not properly supplemented, the glass tube that is operated to generate heat for heating might get broken due to excessively high temperature. This is a drawback of the conventional mechanical heater that must be improved and overcome.

### SUMMARY OF THE INVENTION

An objective of the present invention is to provide an off-water shutdown protection mechanical heater that ensures electricity can be quickly cut off after removal out of water.

To achieve the above objective, the present invention comprises a tube and a cap mounted to an end of the tube, wherein the tube comprises, as being arranged in an interior thereof, an off-water protection transducer, one of a relay and a bidirectional triode thyristor (TRIAC), a circuit board that includes a bimetal plate, and a heating element, wherein the off-water protection transducer, the one of the relay and the TRIAC, the bimetal plate, and the heating element are electrically connected in sequence to form a control loop; wherein when the off-water protection transducer detects a situation of being immersed in water, the one of the relay and the TRIAC turns on to conduct electricity and the bimetal plate detects a temperature of water and undergoes deformation by the temperature to control the heating element to generate heat or not; and when the off-water protection transducer detects a situation of being removed out of water, the one of the relay and the TRIAC turns off to cut off electricity, making the heating element not generating heat.

The off-water protection transducer is used to ensure that electricity is quickly cut off upon removal out of water so as to prevent the prior art problem of excessively high residual heating that results in breaking of the glass tube due to high temperature.

### BRIEF DESCRIPTION OF THE DRAWINGS

FIG. 1 is an exploded view of the present invention.

FIG. 2 is a schematic view showing inside details of a tube of the present invention.

FIG. 3 is a control logic block diagram for off-water shutdown protection according to the present invention.

### DETAILED DESCRIPTION OF THE PREFERRED EMBODIMENT

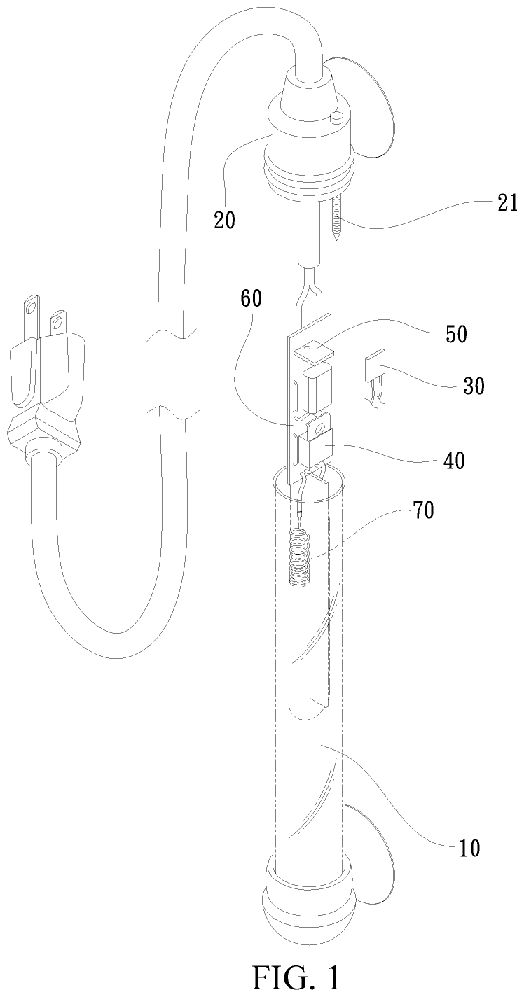

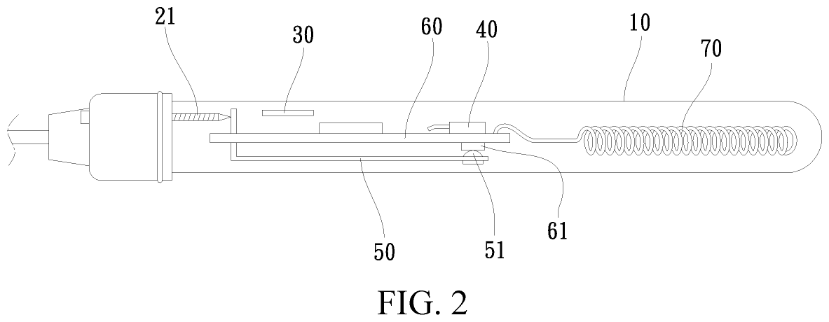

Referring to FIGS. 1 and 2, the present invention comprises a tube 10 and a cap 20 mounted to an end of the tube 10. The tube 10 comprises, as being arranged in an interior thereof, an off-water protection transducer 30, one of a relay and a bidirectional triode thyristor (TRIAC) 40 (wherein a TRIAC 40 is shown in the drawings as an example for illustration of the embodiment, because a TRIAC 40 provides the same function and effectiveness as a relay), a circuit board 60 that includes a bimetal plate 50, and a heating element 70, wherein the off-water protection transducer 30, the one of relay and TRIAC 40, the bimetal plate 50, and the heating element 70 are electrically connected in sequence to form a control loop.

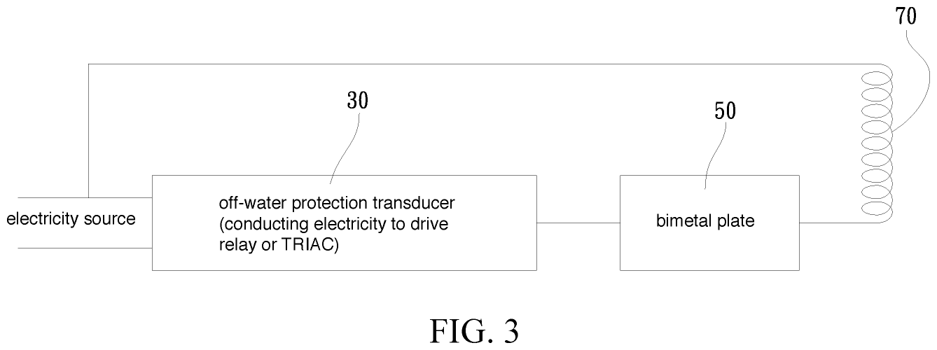

Referring to FIGS. 2 and 3, when the off-water protection transducer 30, the one of relay and TRIAC 40 turns on to conduct electricity and the bimetal plate 50 detects a temperature of water and undergoes deformation by the temperature to control the heating element 70 to generate heat or not.

It is further noted that in FIG. 2, the aquarium water temperature detected by the bimetal plate 50 does not reach a temperature that is sufficient to cause deformation of the bimetal plate 50, so that a contact terminal 51 of the bimetal plate 50 maintains contacting with a contact terminal 61 of the circuit board 60 without being sprung therefrom, and the heating element 70 maintains generation of heat; with the heating element 70 maintains continuous generation of heat, when the aquarium water temperature detected by the bimetal plate 50 is raised to be sufficient to cause deformation of the bimetal plate 50, the contact terminal 51 of the bimetal plate 50 is sprung off and separate from the contact terminal 61 of the circuit board 60, thereby making the heating element 70 heating.

When the off-water protection transducer 30 detects a situation of being removed out of water, the one of relay and TRIAC 40 turns off to cut off electricity, making the heating element 70 not generating heat.

The efficacy of the present invention is that the off-water protection transducer 30 is used to ensure that electricity is quickly cut off upon removal out of water so as to prevent the prior art problem of excessively high residual heating that results in breaking of the glass tube due to high temperature.

Referring to FIGS. 1 and 2, in an embodiment, the cap 20 is connected, through screwing, with a regulation rod 21, wherein an end of the regulation rod 21 is movable, through screwing and rotating, to contact one side of the bimetal plate 50 in order to adjust a degree of deformation of the bimetal plate 50 upon being heated and thus adjusting a temperature level at which the bimetal plate 50 undergoes deformation thereby making it possible to regulate the aquarium temperature.

In an embodiment, the tube 10 is selected as a glass tube.

In an embodiment, the heating element 70 is selected as an electric heating filament.

In summary, the present invention indeed fulfils an expected goal and provides an off-water shutdown protection mechanical heater, which possesses utilization.

I claim:

1. An off-water shutdown protection mechanical heater, comprising a tube and a cap mounted to an end of the tube,
wherein the tube comprises, as being arranged in an interior thereof, an off-water protection transducer, a bidirectional triode thyristor (TRIAC), a circuit board that includes a bimetal plate, and a heating element, wherein the off-water protection transducer, the TRIAC, the bimetal plate, and the heating element are electrically connected in sequence to form a control loop;
wherein when the off-water protection transducer detects a situation of being immersed in water, the TRIAC turns on to conduct electricity and the bimetal plate detects a temperature of water and undergoes deformation by the temperature to control the heating element to generate heat or not; and
when the off-water protection transducer detects a situation of being removed out of water, the TRIAC turns off to cut off electricity, making the heating element not generating heat.

2. An off-water shutdown protection mechanical heater, comprising a tube and a cap mounted to an end of the tube,
wherein the tube comprises, as being arranged in an interior thereof, an off-water protection transducer, a relay, a circuit board that includes a bimetal plate, and a heating element, wherein the off-water protection transducer, the relay, the bimetal plate, and the heating element are electrically connected in sequence to form a control loop;
wherein when the off-water protection transducer detects a situation of being immersed in water, the relay turns on to conduct electricity and the bimetal plate detects a temperature of water and undergoes deformation by the temperature to control the heating element to generate heat or not; and
when the off-water protection transducer detects a situation of being removed out of water, the relays turns off to cut off electricity, making the heating element not generating heat.

3. The off-water shutdown protection mechanical heater according to claim 1, wherein the cap is connected, through screwing, with a regulation rod, such that an end of the regulation rod is movable, through screwing, to contact one side of the bimetal plate in order to adjust a degree of deformation of the bimetal plate upon being heated and thus adjusting a temperature level at which the bimetal plate undergoes deformation for regulating the aquarium temperature.

4. The off-water shutdown protection mechanical heater according to claim 2, wherein the cap is connected, through screwing, with a regulation rod, such that an end of the regulation rod is movable, through screwing, to contact one side of the bimetal plate in order to adjust a degree of deformation of the bimetal plate upon being heated and thus adjusting a temperature level at which the bimetal plate undergoes deformation for regulating the aquarium temperature.

5. The off-water shutdown protection mechanical heater according to claim 1, wherein the tube is selected as a glass tube.

6. The off-water shutdown protection mechanical heater according to claim 2, wherein the tube is selected as a glass tube.

7. The off-water shutdown protection mechanical heater according to claim 1, wherein the heating element is selected as an electric heating filament.

8. The off-water shutdown protection mechanical heater according to claim 2, wherein the heating element is selected as an electric heating filament.
